(19) United States
(12) Patent Application Publication
(10) Pub. No.: US 2008/0221999 A1
(43) Pub. Date: Sep. 11, 2008

(54) System for Issuing Short Life Coupons or Other Promotional Devices

(76) Inventor: Donald Spector, New York, NY (US)

Correspondence Address: DIEHL SERVILLA LLC, 77 BRANT AVE, SUITE 210, CLARK, NJ, 07066, US

(21) Appl. No.: 12/114,371

(22) Filed: May 2, 2008

Related U.S. Application Data
(63) Continuation of application No. 11/464,322, filed on Aug. 14, 2006.
Application No. 11/464,322 is a continuation of application No. 09/589,313, filed on Jun. 7, 2000, now Pat. No. 7,206,754.
Application No. 09/589,313 is a continuation of application No. 11/312,218, filed on Dec. 20, 2005.
Application No. 11/312,218 is a continuation of application No. 09/589,313, filed on Jun. 7, 2000, now Pat. No. 7,206,754.

(51) Int. Cl. G06Q 30/00

(52) U.S. Cl. 705/14; 705/1

(57) ABSTRACT

An improved short life coupon system which allows a television viewer to select discount or promotional coupons while viewing a television commercial. Coupon information relating to the commercial is sent to a central station which also contains up-to-date point-of-sale information. This information is analyzed by the central station so that the coupon can be specifically designed to satisfy the viewer and maximize sales.

### CROSS-REFERENCE TO RELATED U.S. APPLICATIONS

This Application is a continuation under 35 U.S.C. 120 of U.S. patent application Ser. No. 11/464,322, filed Aug. 14, 2006, which is a continuation of U.S. patent application Ser. No. 09/589,313, filed Jun. 7, 2000, now issued as U.S. Pat. No. 7,206,754 on Apr. 17, 2007, the teachings of which are hereby incorporated by reference in their entirety. This Application is also a continuation under 35 U.S.C. 120 of U.S. patent application Ser. No. 11/312,218, filed Dec. 20, 2005, which is a continuation of U.S. patent application Ser. No. 09/589,313, filed Jun. 7, 2000, now issued as U.S. Pat. No. 7,206,754 on Apr. 17, 2007, the teachings of which are hereby incorporated by reference in their entirety.

### FIELD OF THE INVENTION

This invention relates generally to systems for generating merchandising coupons, such as discount or promotional coupons which, when issued to a consumer, entitle the consumer to specified discounts or other benefits on those items identified by the coupons. More particularly, the instant invention is directed to a television driven short life coupon system which allows the manufacturer of a particular product to instantaneously modify issued coupons based on redemption information and point-of-sale information.

### BACKGROUND OF THE INVENTION

A merchandising coupon is often referred to as a “cents-off” or discount coupon or alternatively a promotional coupon. The holder of the coupon, when purchasing the product identified on the coupon from the retailer, is given a specified discount or other promotional benefit. Such coupons fall into two basic classes-those printed and put into distribution by manufacturers, and those which retailers print for use in their stores.

The majority of merchandising coupons are authorized by the manufacturer of the product so that the manufacturer is required to pay to the retailer the face value of each coupon redeemed, plus certain handling charges. For example, on occasion the Coca-Cola Company runs ads which include a coupon offering 25 cents towards the purchase of a pack of “Coca-Cola” bottles. The retailer who accepts this coupon gives the purchaser of the pack a 25 cent reduction on the market price thereof. The retailer is then entitled to recover from the Coca-Cola Company this 25 cent discount, plus seven cents for handling costs (or whatever other handling charge is indicated).

Despite the high cost of merchandising coupon transactions, the volume of coupon traffic has risen over the years to a phenomenal level. Though only a fraction of the many billions of coupons which are distributed are actually put to use by shoppers, the number of coupons which are redeemed still runs into the billions.

Experience has shown that cents-off coupons and promotional coupons constitute a cost-effective promotional technique for stimulating consumers to try out a new product or to switch brands. Moreover, when sales of a given brand are flagging, merchandising coupons often serve to revive and even increase such sales. Merchandising coupons therefore benefit the consumer, the manufacturer and the retailer.

While in some instances coupons accepted by the retainer are redeemed by sending them directly back to the company making the product most coupons first go through a clearing house where, after the coupons have been manually sorted, they are shipped by the clearing house to the respective manufacturers who then invoice the money payable to the clearing house.

With existing procedures, the manufacturer has little control over the number or value of coupons redeemed. By statistical analysis of previous coupon promotions, the manufacturer can make a projection of anticipated redemptions. However, if a coupon was issued for a larger than usual discount and the redemption rate was higher than expected, the manufacturer may then incur a greater promotional expense than projected.

Also, with the existing procedures, the time elapsing between issuance and redemption of a coupon can be many months, particularly if the coupon carries an expiration date which gives the shopper a long term in which to use the coupon. This makes planning for future promotions difficult, for information on coupon redemptions in previous promotions is slow to arrive.

Quite distinct from these problems is the failure of many shoppers to take advantage of merchandising coupons. While a shopper may save coupons mailed to him or her or may clip and file coupons appearing in newspapers and magazines, the shopper often forgets to take them along when going shopping and therefore will not be induced to make a discretionary purchase or switch brands. Typically, a consumer will receive in the mail a merchandising coupon, say, for a new hair shampoo; but it will be several days before the next shopping trip, and by that time the shopper may have forgotten about the coupon and will therefore purchase the usual brand.

U.S. Pat. No. 5,176,224 issued to Donald Spector on Jan. 1, 1993, the inventor of the instant application, proposed one unique solution to the foregoing coupon distribution problem. In this patent, Mr. Spector proposed a controlled-loop computer-controlled merchandising coupon system where a coupon printer-dispenser would be installed at each supermarket, making it possible for a shopper to receive a merchandising coupon entitling him or her to a specified discount on the product identified in the coupon. Advantageously, this patent also disclosed that the manufacturer would be provided with a readout of the discount coupon transactions so that the manufacturer could subsequently alter the discount amount on the basis of the coupons being presented by the consumer.

Another coupon distribution system is described in U.S. Pat. No. 5,249,044, issued to Harry Von Kohom on Sep. 28, 1993. This patent describes a system for generating product coupons at remote locations, including a consumer's home. The system, includes an apparatus for receiving and storing product information signals broadcast from a central television broadcast location. The apparatus is connected to a consumer's television at a remote location, which television includes a coupon generating unit. When the consumer views a product of interest, the system can be activated, and if available the consumer can have a discount coupon printed at his or her home for later presentation to a retail outlet. The possibility to receive a coupon at home was an advance in the art but still did not give the manufacturer the ability to monitor coupon distribution and tailor such distribution to enhance particular product sales. Other similar patents in this area include U.S. Pat. Nos. 5,500,681 and 5,978,013. The teachings of the '044, '681 and '013 patents are incorporated herein by reference.

A further improvement is disclosed in U.S. Pat. No. 5,287,181. In this system, coupon related data is encoded in a television signal transmission, which data is decoded and displayed on the television screen. Upon viewing the indicia on the television screen, the user can manually and selectively extract the coupon-related data from the television signal transmission. After an optional editing function, the extracted coupon-related data is stored on a recording medium such as a magnetically striped card, for subsequent readout and redemption. This system also envisions that consumer information would be provided to the manufacturer, upon redemption of the coupons. In this embodiment the manufacturer would be able to determine results in the amount of usage of the coupons, the demographics of usage and detailed information about the consumer.

This system however, does not show or suggest a method or apparatus with which a manufacturer could make decisions regarding coupon usage on a real time basis and tailor coupon issuance accordingly.

An additional problem with the prior art coupon delivery systems via television is the recent introduction of Personal Video Recorders (PVR) which consist of a set-top box equipped with a large capacity hard drive. Incoming television signals are digitalized and stored on the hard drive, allowing the consumer to view replays, catch-up on shows already in progress, index and select recorded shows and most importantly, eliminate commercial advertisements. The ability of a consumer to eliminate commercials is a major problem for manufacturers due to the large amounts of money currently spent by manufacturers on advertising, and the possibility that those ads will not be watched by consumers.

It is therefore one object of this invention to provide an incentive for consumers equipped with PVR's to view commercials by offering product discount coupons tied to a specific commercial.

It is a further object of this invention to provide instant coupon feedback information to a manufacturer regarding their coupon discount program.

It is a still further object of this invention to provide coupon feedback information to a manufacturer before the coupon is issued for redemption.

It is another object of this invention to allow a manufacturer to tailor it's coupon discount program in real time based on point-of-sale information, thereby allowing manufacturers to maximize profits and sales.

### SUMMARY OF THE INVENTION

In accordance with the invention, a television receiver is located at a viewer's premises, the television receiver including a remote control unit, and may include a Personal Video Recorder (PVR) or other device capable of sending data over a telephone line or other communications highway.

Located at the viewer's premises is also a data processing terminal, such as a Personal Computer, which may also be the television and hard drive and function as a DRV, which responds to a request for a product discount coupon via the television remote control. In response to a coupon request, information is transmitted by the personal computer to a central station maintained by the broadcaster of the television program or a third party platform site.

The broadcaster central station then transmits a coupon request to a manufacturer's coupon generator station. Advantageously, this request will include information identifying the product of interest and may include viewer profile information.

The coupon request information is received at the manufacturer's coupon generator and compared with previously stored point-of-sale information, i.e., how the product is selling in a particular geographic area or to a defined consumer group.

The received information and the previously stored information is then analyzed to permit the manufacturer to issue a coupon or other promotional device tailored to the consumer and designed to maximize sales.

### BRIEF DESCRIPTION OF THE DRAWING

FIG. 1 illustrates a block diagram of the inventive system for issuing short life coupons, or other promotional devices.

### DESCRIPTION OF THE INVENTION

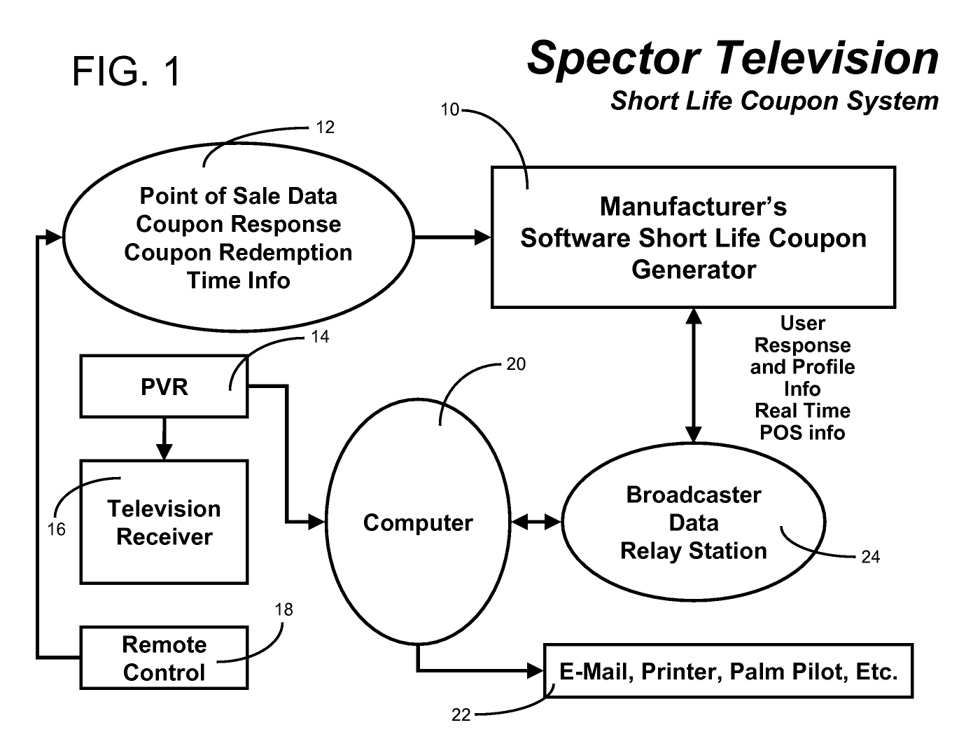

Referring now to FIG. 1, there is shown one embodiment of the instant invention.

Television receiver 16 is located at a consumer location. Attached thereto or part of the system is a remote control device 18 as well as a Personal Video Recorder (PVR) 14. It is to be understood that the PVR could be replaced by any other device capable of transmitting and receiving data over a telephone line or other communications highway. As described above, the PVR (or equivalent) can store and replay video presentations, including the ability to eliminate commercials. The PVR is connected to computer 20, which can be remote or located at the consumer site. It is to be understood that PVR 14 could also be replaced with a standard set-top box with the ability to communicate with computer 20 or in fact be part of the computer itself.

Computer 20 also communicates with Broadcaster Data Relay Station 24 and can provide e-mail or data transfer to a consumer's printer, Palm Pilot, Cell Phone or equivalent and or other communication devices as shown at 22.

The Broadcaster Data Relay Station 24 or separate platform also communicates with the Manufacturer's Software Short Life Coupon Generator 10 to provide user response and profile information as well as time information i.e., what product is being shown when a consumer is viewing a commercial.

It is to be understood that a short life coupon means a discount coupon that is valid for a relatively short predetermined period of time and valid only for a specific product or products.

This term can also include other promotional devices which are distinct from discount coupons.

In operation, television receiver 16 connected to PVR 14, or other set-top box) displays a commercial on the screen. An interested customer sees a commercial and decides to request a

Short Life Coupon. The customer then pushes a button on the remote control to request the Short Life Coupon. In order to induce the customer to view the commercial in this example, the customer would not be able to request the coupon until the end of the commercial.

The PVR (or set-top box or other communications device) sends a request for a coupon (time related to the specific commercial) through a phone line (or cable) and through a pass through line in the home computer 20 to the Broadcaster Data Relay Station 24. This station bounces back coded appropriate demographic information on the user (profiles and time) to the Manufacturer's Software Short Life Coupon Center 10.

Center 10 is a data bank with software that also receives up to the minute point-of-sale (POS) information on the products being offered, as well as information on coupon responses and redemptions as shown at 12. The program in the Manufacturer's Short Life Coupon Generator Station 10 analyzes this information to provide maximum yield in moving product or services.

The Manufacturer's Coupon Generator 10, might make different offers in different localities depending on local conditions. For example, if the weather is cold during the summer and Coke is not moving well, it may offer a bigger discount in that location). Its offers can be location driven and are related to product sales of either a store, or a series of stores in one location. The Manufacturer's Coupon Generator may also be hooked into a retailer's promotion in an area. Unlike many other coupons a Short Life Coupon will usually be of higher value and may only be honored by a specific retailer in one region. A person who is going out of business may contact a manufacturer and make a deal to “Blow Out” merchandise at dramatically reduced prices. Perishable goods that are about to expire might also be severely discounted.

The Manufacturer's Coupon Generator 10 might also look at the customer's profile and realize that he or she only responds to big offers. In that instance, the manufacturer might choose to offer a shorter time length for this person's coupons but with a bigger discount, or might say that the service is unavailable and switch the consumer to a related product that the company sells. If the products being offered are selling well, offers for new products or other products might be offered.

The Coupon Generator 10 sends these coupons to the user's personal computer (or stand-along box) where they can be printed or electronically stored for use at a retailer (i.e., a customer can display his electronic coupon in the store from the screen of his cell phone, Palm Pilot, or other personal electronic device).

In certain circumstances, it is envisioned that these discounts can automatically be filled online, if so requested. Therefore, a company might make a special limited offer and not even print a coupon but have the discount applied automatically when the product is purchased via an online participating partner.

The redemption rate of the Short Life Coupons is factored into the Coupon's Generator's Point of Sale data and adjusts the discounts and offers accordingly.

The Short Life Coupon system is totally interactive with sales data at specific times and always allows the manufacturer (or retailer) to know exactly where he is (without having overhang of millions of dollars of unused coupons).

The system also allows a manufacturer to have a significant advantage over his competition in the marketplace.

Because larger than usual valuable discounts will be offered, it also gives people a reason to want to watch commercials which is important for consumers using a PVR.

It is also envisioned that trivia questions, for example could be printed on the coupons, which require answers from the consumer. In this way, the coupons could also be used as a sweepstakes vehicle.

It is also envisioned that the computer that is connected to the television can measure the user's profile and pull up from a file of commercials, a commercial most suited to the likes of the viewer. That commercial being broadcasted to the PVR, DVR or computer television screen in which the consumer reacts by selecting the service with a remote control or other mechanism that communicates with the physical system.

The foregoing description is only illustrative of the invention. Various alternatives and modifications scan be devised by those skilled in the art without departing from the spirit of the invention. Accordingly, the present invention is intended to embrace all such alternatives, modifications and variances which fall within the scope of the appended claims.

I claim:

1. A Personal Video Recorder (PVR), DVR or device such as a computer that includes such a device for encouraging a viewer to watch a stored commercial advertisement, comprising:
the stored commercial advertisement enabled for requesting a coupon for discount for a product or a service, the coupon in response to the request being delivered to the viewer and the coupon being uniquely tied to the commercial advertisement; and
a remote control or action connected to the device, enabling the viewer to make a request for the coupon.

2. The PVR, DVR or device of claim 1, wherein the remote control is enabled to make the request at a predetermined moment in the commercial advertisement.

3. The PVR, DVR or device of claim 2, wherein the predetermined moment is at an end of the commercial advertisement.

4. The PVR, DVR or device of claim 1, wherein the discount is larger than usual discounts.

5. The PVR, DVR or device of claim 1, wherein the discount is provided for purchasing one or more of the product or service available at a retailer in an area or for a perishable good or service.

6. A method for receiving a coupon by a viewer by requesting the coupon for a discount for a product or a service in a television presentation, comprising:
making a request by the viewer for the coupon and sending the request over a network to a coupon generator;
receiving a request by the coupon generator, a received request including information related to the viewer and the product, the coupon generator having access to recent point-of-sale information about the product;
automatically analyzing by the coupon generator of relevant information related to the received request;
generating of the coupon by the coupon generator, the coupon being optimized for providing maximum yield in selling products or services; and
sending the coupon as an electronic message to the viewer.

7. The method of claim 6, wherein the received request reaches the coupon generator from a Broadcast Relay Station.

8. The method of claim 6, wherein the connection is a communications highway.

9. The method of claim 6, wherein making of the request is performed by pushing a button on a remote control.

10. The method of claim 6, wherein the coupon can only be requested at the ending of the television presentation.

11. The method of claim 6, wherein the relevant information includes one or more of the location of the viewer or information about weather conditions.

12. The method of claim 6, wherein the coupon is valid for one or more of a limited period of time, at a specific retailer or for a perishable good.

13. The method of claim 6, wherein the coupon is adjusted to a redemption rate.

14. The method of claim 6, wherein the content of the coupon comprises a trivia question.

15. The method of claim 6, further comprising receiving the coupon by the viewer on a personal electronic device.

16. The method of claim 15, wherein the personal electronic device is a cell phone.

17. The method of claim 6, wherein the coupon is applied to an online purchase.

18. A personal electronic device for receiving a discount coupon for a product in electronic form, comprising:
means for receiving and storing the discount coupon, the discount coupon being requested from a coupon generator in a coupon request by a viewer of a television presentation, the request reaching the coupon generator as a message through a network, a request reaching the coupon generator including information about the product and the viewer; and
means for using the coupon at a retailer.

19. The personal electronic device of claim 18, wherein the means for using the coupon at a retailer is a screen of the device.

20. The personal electronic device of claim 18, wherein the personal electronic device is a cell phone.

21. The personal electronic device of claim 18, wherein the coupon is requested by the viewer by pushing a button on a remote control.

22. The personal electronic device of claim 18, wherein the request is transmitted over a communications highway.

23. A personal electronic device comprising a coupon generator for processing of a request for a coupon for discount for a product or a service by a viewer of a television presentation, comprising:
means for receiving a coupon request over a network, the coupon request including information relating to the product or the service for which the coupon is intended and information relating to the viewer, the request being transmitted over a network;
a databank having information relating to the product or the service;
software to analyze relevant information relating to the product or the service and the viewer;
software to generate a coupon that maximizes sales of the product or the service; and
means to send the coupon in electronic form to the viewer.

24. The personal electronic device of claim 23, wherein the network is a communications highway.

25. The personal electronic device of claim 23, wherein the coupon request reaches the coupon generator from a Broadcaster Data Relay Station.

26. The personal electronic device of claim 23, wherein the requesting of the coupon is performed by pushing a button on a remote control by the viewer.

27. The personal electronic device of claim 23, wherein the coupon can only be requested at the ending of the television presentation.

28. The personal electronic device of claim 23, wherein the relevant information includes one or more of information regarding the location of the viewer or information about weather conditions.

29. The personal electronic device of claim 23, wherein the coupon is valid for one or more of a limited period, at a specific provider of goods or services or for a perishable good or service.

30. The personal electronic device of claim 23, wherein the coupon is adjusted to a redemption rate.

31. The personal electronic device of claim 23, wherein the coupon comprises a trivia question.

32. The personal electronic device of claim 23, further comprising receiving the coupon by the viewer on a personal electronic device.

33. The personal electronic device of claim 32, wherein the personal electronic device is a cell phone.

34. The personal electronic device of claim 23, wherein the coupon is applied to an online purchase.

35. A system for displaying commercials to a user having a profile, the system comprising:
a database of commercials;
a PVR, DVR or computer hard drive connected to or part of a television;
a network connecting the database of commercials to the user's PVR, DVR or computer hard drive; and
a system for selecting at least one commercial from the database that fits the profile of the user, the system being able to transmit the commercial over the network to the PVR, DVR or computer hard drive of the user.
